(19) United States
(12) Patent Application Publication
(10) Pub. No.: US 2014/0201075 A1
(43) Pub. Date: Jul. 17, 2014

(54) TRANSACTION SYSTEM AND METHOD

(71) Applicant: The Royal Bank of Scotland plc, Edinburgh (GB)

(72) Inventors: John King, Edinburgh (GB); Alan Yuill, Edinburgh (GB)

(73) Assignee: The Royal Bank of Scotland plc, Edinburgh (GB)

(21) Appl. No.: 14/199,406

(22) Filed: Mar. 6, 2014

Related U.S. Application Data
(63) Continuation of application No. PCT/EP2012/067675, filed on Sep. 10, 2012.

(30) Foreign Application Priority Data
Sep. 8, 2011 (GB) 1115543.9

(51) Int. Cl. G06Q 20/22; G06Q 20/32

(52) U.S. Cl. CPC G06Q 20/223; G06Q 20/32
USPC 705/43; 705/42

(57) ABSTRACT

A method and device of performing a person-to-person payment from a wireless personal communications device of an originator to a wireless communications device of a recipient is provided. The method include transferring a respective blind payment identifier, which is associated with a payment having a monetary value, from a wireless personal communications device of the originator to a wireless personal communications device of the recipient by using a direct device-to-device communications protocol. The personal communications device includes means arranged to communicate wirelessly with a remote payment system to set up a payment therewith including by obtaining and storing a blind payment identifier; and means arranged to communicate directly with a proximal, second personal communications device and impart the blind payment identifier thereto.

### TECHNICAL FIELD

The disclosure relates to transactions and in particular, but not exclusively, to person-to-person payment transactions made using personal communications devices.

### BACKGROUND

Personal communications devices (such as, without limitation, mobile telephones, smartphones, personal digital assistants, tablet PCs, etc.), which will be referred to herein as PCDs, can be used nowadays for many so-called online banking and/or financial operations. Such online banking operations include making payments, typically from one account to another account or from an account to a person.

As used herein, an ‘account’ is used broadly to encompass any kind of financial account that stores monetary value or provides a credit facility, and also any other kind of value that can be added to or deducted from. For example, apart from monetary value, an account could store ‘points’ such as Airmiles™ or other kinds of accruable reward points, or the like, which can be used as a currency instead of money in certain kinds of transactions.

Online banking operations are also known for performing electronic person-to-person (PTP) payments, which typically require an originator of a payment (a “payer”) to set up the payment at a financial institution of the originator, including by identifying the intended recipient (or, “beneficiary”) of the payment (and the means by which the financial institution can communicate with the recipient), and the financial institution to communicate information to the pre-identified recipient, in order that the recipient can obtain the associates funds.

For example, EP1783676 describes a method by which an originator can set up a payment order so that a recipient can obtain cash at a cardless teller machine by virtue of the payment order. In effect, the originator sets the payment order up by using short message service (SMS) communications with their own bank. The SMS communications identify at least the recipient and the amount. After authentication is performed by the bank, the bank communicates the payment order to the identified recipient using SMS, the payment order identifying the amount and the identity of the payer and providing a code or PIN, and the recipient is enabled to withdraw a respective amount of cash from the cardless teller machine, using the information provided in the payment order.

### SUMMARY

According to an aspect, the present disclosure provides a method of performing a person-to-person payment, from a wireless personal communications device of an originator to a wireless communications device of a recipient, by transferring a respective blind payment identifier, which is associated with a payment having a monetary value, from a wireless personal communications device of the originator to a wireless personal communications device of the recipient by using a direct device-to-device communications protocol.

According to another aspect, the present disclosure provides a personal communications device, comprising: means arranged to communicate wirelessly with a remote payment system to set up a payment therewith including by obtaining and storing a blind payment identifier; and means arranged to communicate directly with a proximal, second personal communications device and impart the blind payment identifier thereto.

According to another aspect, the present disclosure provides a method of performing a transaction comprising: a requester controlling a wireless personal communications device to communicate wirelessly with a remote payment system to obtain a payment identifier having a specified monetary value; the remote payment system generating the payment identifier, associating it with the monetary value, including by ring-fencing the monetary value in an account of the respective requester, and returning the payment identifier to the wireless personal communications device; and the requester causing the payment identifier to be received by a cash dispensing machine, whereby the cash dispensing machine validates the payment identifier with the remote payment system and delivers a respective amount of cash to the requester,

Other aspects and alternatives of the present disclosure will become apparent from the following description and claims and the accompanying drawings.

### BRIEF DESCRIPTION OF THE DRAWINGS

Various features and advantages of the disclosure will become apparent from the following description of alternatives of the disclosure, given by way of example only, which is made with reference to the accompanying drawings, of which:

FIG. 1 is a block diagram of an exemplary banking system capable of being used for transactions according to examples of the present disclosure;

FIG. 2 is a high level process flow diagram of an exemplary P2P transaction according to an example of the present disclosure;

FIG. 3 is a flow diagram of an exemplary process of setting up a payment according to an example of the present disclosure;

FIG. 4 is a high level process flow diagram of the completion of a payment transaction according to an example of the present disclosure;

FIG. 5 is a flow diagram of a procedure for withdrawing cash from an ATM according to an example of the present disclosure;

FIG. 6 is a flow diagram of a procedure for transferring funds into a recipient account according to an example of the present disclosure;

FIG. 7 is a flow diagram of a procedure for reversing ring fencing of funds according to an example of the present disclosure; and

FIG. 8 is a functional block diagram of an exemplary smartphone suitable for operating according to an example of the present disclosure.

### DETAILED DESCRIPTION

Various examples of the present disclosure will now be described in more detail with reference to the accompanying drawings. It will be appreciated that the disclosure is not limited in its application to the details of method and the arrangement of components as set forth in the following description or illustrated in the drawings. It will be apparent to a person skilled in the art that additional examples and variations of the present disclosure not detailed in the description are possible and will fall within the scope of the present claims. Accordingly, the following description should not be interpreted as limiting in any way, and the scope of protection is defined solely by the claims appended hereto.

Examples described herein aim to provide an alternative way of performing electronic PTP payments. Broadly-speaking, examples do not require an originator of a payment to identify to their bank a recipient of the payment, for example, in advance of a payment being performed, or even at all. Moreover, a payment to a recipient can be facilitated (at least according to ‘ATM examples’ below) without the recipient having a bank account. In this context, according to certain examples, a payment recipient can be anonymous, insofar as the payer's bank does not need to have any information about the recipient or his or her bank in order to facilitate a PTP payment.

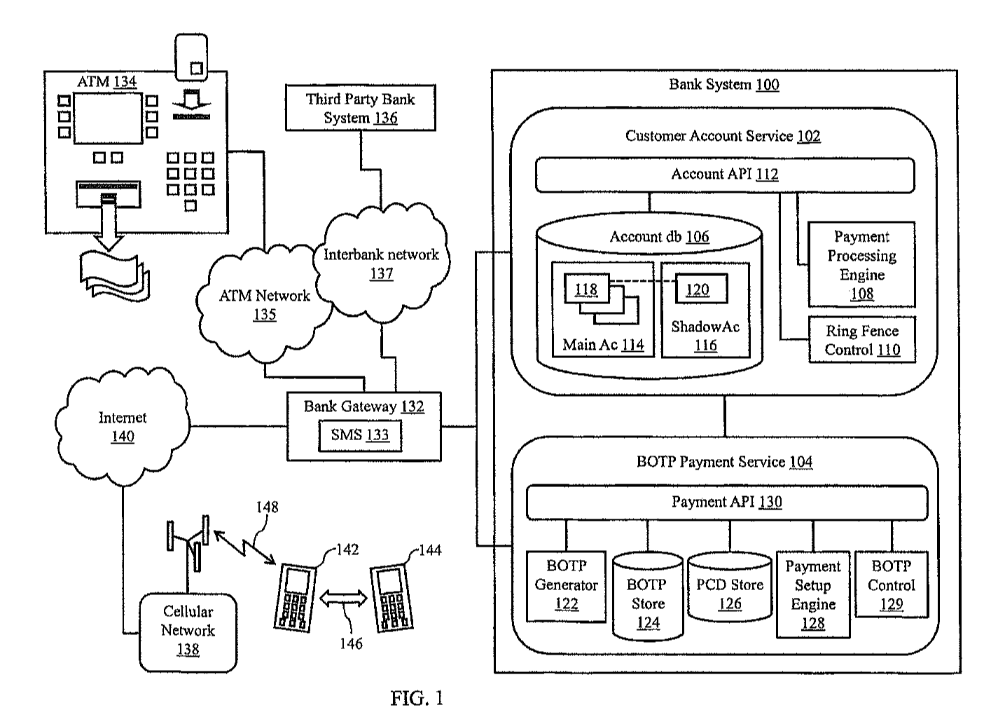

A system for use according to a first illustrative example is provided in FIG. 1. The system comprises a bank system 100, having a customer account service 102 and a blind one-time-passcode (BOTP) payment service 104. In this example, the system is a ‘bank’ system but could more generally be described as a system belonging to, controlled by or provided for any financial institution or financial services company. The service is said herein to be ‘blind’ inasmuch as payments are set up in and facilitated by a bank without knowledge of the intended recipient or any recipient contact details, account details, PCD details or any other information identifying the recipient or a respective PCD of the recipient. Indeed, at the time of setting a payment up, the payment originator himself may not know who the intended recipient is, though that will typically become apparent on making the payment in person to the eventual recipient. In this manner, the payment service provides a PTP payment mechanism that is closely analogous to a cash transaction, where cash can of course be withdrawn from a bank and handed to anyone without informing the bank of the intended recipient.

The customer account service 102 generally is responsible for managing customer accounts, including making payments into accounts, payments out of accounts, account transfers, servicing balance enquiries, and the like. The BOTP payment service 104 is generally responsible for setting up and managing one-time payment requests, as will be described. The customer account service 102 and the BOTP payment service 104 are in communication with one another.

The customer account service 102 includes a customer account database 106, payment processing engine 108 and a ring fence control 110. All interactions with the customer account database 106, including by the payment processing engine 108, the ring fence control 110, any element of the BOTP payment service 104 and any external requests (e.g. from an ATM) are via an account application programming interface (API) 112. The customer account database 106 holds main customer accounts 114, of which only three are shown, and shadow customer accounts 116. A shadow customer account 120, as will be described, is created whenever a customer account 118 is subject to ring-fencing for the purposes of a one-time payment. A shadow customer account 120 can also be thought of as a virtual account, which is associated with a main account, and which may be created on demand (and deleted after use) or exist permanently with the respective main account. In alternative examples, ring-fencing can be managed by an appropriate process within a customer account, without the need to create or manage a shadow customer account 120 as such. However, for ease of understanding herein, an example employing shadow accounts will be described.

The BOTP payment service 104 comprises a BOTP generator 122 a BOTP store 124, a PCD store 126 and a payment setup engine 128. All interactions with the BOTP store 124 and the PCD store 126, including by the BOTP generator 122, the payment setup engine 128 and any element of the customer account service 102, according to the present illustrative example, are via a payment API 130.

The bank system 100 can be accessed by external sources via a bank gateway 132, which controls the routing of external communications to and from the bank system 100. The bank gateway 132 includes an SMS function 133, by which the bank system 100 is able to generate SMS messages, which can be delivered to customers, for example, via the cellular network 138, if required. As shown in FIG. 1, access to the bank system 100 can be provided to automated teller (ATM) machines 134 via an ATM network 135, which is connected to the bank gateway 132. In addition, a third party bank system 136 (or systems) can also connect to the bank system 100, or vice versa, via an interbank network 137 and the bank gateway 132. Such third party bank systems may be similarly configured to the bank system 100. Moreover, access to the bank system 100 can also be provided to PCDs, via a cellular network 138, which is connected to the bank gateway 132 either directly or via another network, such as the Internet 140. The bank gateway 132, of course, provides various other connections into the bank system 100, for example, for POS payment systems located in merchant premises. Also shown in FIG. 1 is a payer PCD 142 (a smartphone, in this example, belonging to a payer and operating a payment delivery application, which functions according to the following description), and a recipient PCD 144 (a smartphone, in this example, belonging to a recipient and operating a payment receipt application, which functions according to the following description). In practice, each smartphone would typically have loaded onto it a general payment software application, comprising both payment delivery and payment receipt components, which operate generally as will be described below.

In the present context, a recipient is simply someone who receives a payment from a payer. As shown, the payer PCD 142 can be arranged to be in communication with the recipient PCD 144 using a direct, device-to-device (DTD) protocol 146, for example, employing near-field communications (NFC) or, indeed, any other known or future suitable proximity protocol (e.g. the TransferJet™ protocol as developed by the TransferJet™ Consortium). Another suitable protocol may be by infra-red transmission (e.g. conforming to IRDA), or one PCD may even be adapted to image the screen of another PCD on which a code is displayed. For example, the code may be displayed as a one-dimensional or a two-dimensional barcode (e.g. a QR Code). According to the present example, “direct, device to device protocol” implies that no intermediary system, network, device or apparatus is involved in the associated communications. This is in contrast with normal cellular communications, in which a cellular network (and the well-known associated systems and components) provides communications between two PCDs, even if the PCDs are in the same proximity as one another.

According to the present example, the payer PCD 142 communicates (as, indeed, can the recipient PCD 144, if required) with the bank system 100 using normal Internet protocols (e.g. HTTPS) using cellular communications signalling 148 via the cellular network 138 (or by other means such as via Wi-Fi or Bluetooth tethering) and the Internet 140. The payment delivery and receipt applications are arranged to communicate with the BOTP payment service 104 of the bank system 100.

### PTP Payment Process

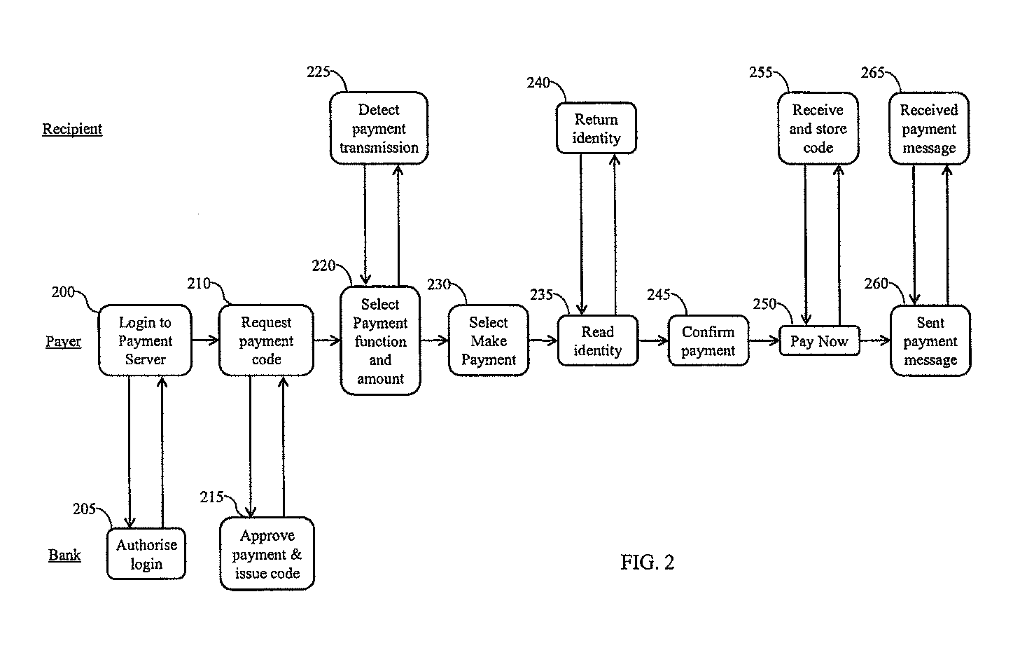

According to one example, an exemplary PTP payment process is performed as follows, with reference to the flow diagram in FIG. 2. In the following description, numerals within square brackets represent process steps corresponding to the process steps that are as illustrated in the accompanying flow diagrams.

In a first step [step 200], the payer PCD 142 uses the payment delivery application to initiate communications with, and login to, the BOTP payment service 104. The payer is required to login to the BOTP payment service 104 by providing private login information, for example a user name and a password (though, obviously, other known and appropriate techniques, for example biometrics, may be employed for gaining access to the payment server 114), which is authorised by the BOTP payment service 104 (for example, by using information held in the PCD store 126).

According to the present example, in order to be able to login to the BOTP payment service 104, the payer must previously have registered the payer PCD 142 with the PCD store 126, using an appropriate online sign-up process. Once the payer has signed up to the service, the details of the payer PCD 142 (for example, SIM code, device name, telephone number and/or device model), and the private login information, are stored by the PCD store 126. Thus logging in, according to the present example at least, requires both provision by the payer of private login information and use of a registered payer PCD 142. Other greater or lesser levels of authentication may be deemed appropriate in other scenarios.

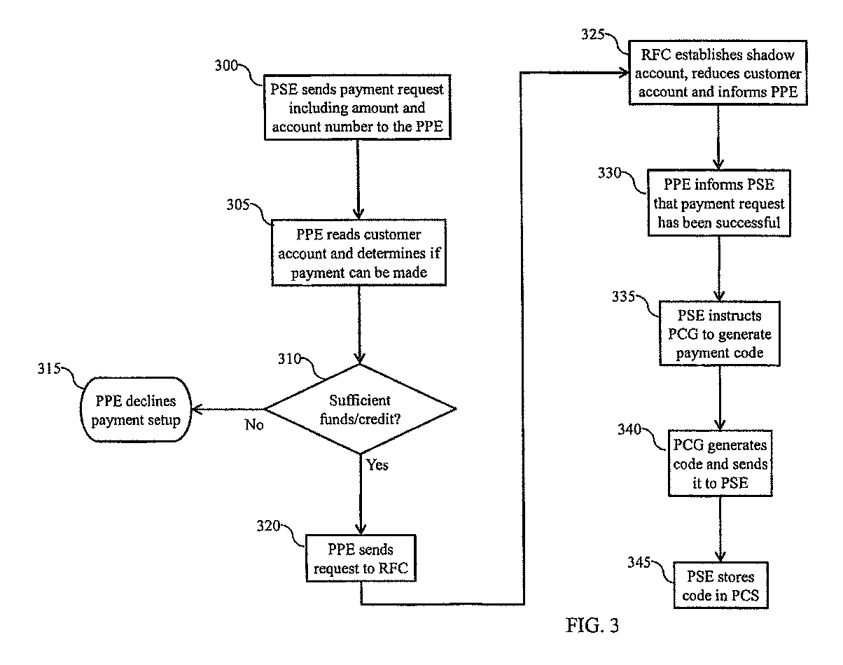

Having logged in, the payer controls the payment delivery application to request [210] a payment code, specifying an account 118 from which the funds should be taken and an amount of the payment. In other examples, the payer PCD 142 may be associated by the bank with a particular account, in which case specifying the account may not be required. In response (and subject to successful completion of certain steps described below with reference to the flow diagram in FIG. 3), the BOTP payment service 104 issues a payment code [step 215], which is received by and stored in the payer PCD 142.

Once the payer has the payment code, a wireless, DTD payment can be made by the payer PCD 142 to any other appropriately-equipped PCD, as and when required by the payer.

A payer wishing to make a payment to a recipient selects a payment function on the payer PCD 142, selects to make a payment using the received payment code [220], and the payer and recipient move their respective PCDs into close proximity with (or even touching) one another. The payer PCD 142 in response to the payment selection initiates an NFC transmission, which is detected by the recipient PCD 144 [225]. The payer then selects a make payment function [230]. In response, the payer PCD 142 communicates with the recipient PCD 144 and reads the identity thereof [235]. The recipient PCD 144 returns its name to the payer PCD 142 [240]. For the present purposes, the identity is a name, for example “Dave's Phone”, which is recorded by the recipient on the recipient PCD 144. Having received the identity, the payer PCD 142 displays a message to the payer confirming that the payer wishes to make the payment [245]. For example, the payer PCD 142 displays a message “Do you wish to make a payment of £10 to Dave's Phone” (where £10 is the blind payment amount that had been set up). In other examples, for example if increased security is preferred, a randomly generated nonce or similar could be generated and displayed by the recipient PCD 144, and communicated to and displayed by the payer PCD 42, instead of communicating a PCD identity or name as such, so that both parties know (by virtue of the displayed random codes matching) that the two PCDs are communicating with one another.

In any event, the message serves to prompt the payer to complete the payment and also provides confidence to the payer that the payer PCD 142 is communicating with the expected recipient PCD 144, for example, in the event another PCD happens to be in the proximity of the payer PCD 142; though, in practice, such an occurrence would typically be immediately evident as any other PCD would have to be very close to the payer PCD 142 and would thus be evident to both the payer and the intended recipient. If an unexpected response were obtained by the payer, the payment process could simply be terminated by the payer at that point.

If the payer is happy to proceed to make a payment of £10 to Dave's Phone, a pay now option is selected and the payer PCD 142 transmits the payment code to the recipient PCD 144. The recipient PCD 144 stores the payment code, to be saved to an account or redeemed at a later time [255], as will be described below. When the transfer has been completed, the payer PCD 142 displays a message to the payer [260], for example “Payment of £10 successfully made to Dave's Phone” and the recipient PCD 144 displays a message to the recipient [265], for example “Payment code successfully received”. In principle, the payer PCD 142 may transfer additional information, such as payment amount and even an identity of the payer PCD 142; though, such information is not transferred according to the present example, for the sake of added security.

### Setting Up a Payment

According to the flow diagram in FIG. 3, in order to be able to issue a payment code, the payment setup engine 128 sends a payment request, including a payment amount and customer account number, to the payment processing engine 108 [300]. The payment processing engine 108 accesses the specified customer account 118 to determine whether the account can facilitate the requested payment [305]; for example, in terms of having sufficient funds (or sufficient credit). If the payment processing engine 108 determines [310] that there are insufficient funds (or there is insufficient credit), a ‘request rejected’ message is returned to the payment setup engine 128 [315]. If the payment processing engine 108 determines [310] that that there are sufficient funds (or there is sufficient credit), the payment processing engine 108 sends a request to the ring fence control 110 to ring-fence the requested payment amount [320].

According to the present example, the ring fence control 110 establishes a shadow customer account 120 in the customer account database 106, reduces the balance in the customer account 118 by the amount of the requested payment and informs the payment processing engine 108 that ring fencing has been completed [325]. The shadow customer account 120 contains the amount of the requested payment.

Henceforth, any operation performed on the customer account 118 does so based on the reduced balance in the customer account 118, unless the requested payment is, for any reason, not completed. In the case of a payment that is not completed, the amount in the shadow customer account 120 is credited back into the customer account 118, as will be described.

The payment processing engine 108 signals to the payment setup engine 128 that the payment request has been successful [330]. In response, the payment setup engine 128 instructs the BOTP generator 122 to generate a unique payment code [335]. The BOTP generator 122 returns the code to the payment setup engine 128 [340] and the payment setup engine 128 stores the code in the BOTP store 124 [345]. The payment setup engine 128 returns the payment code to the payer PCD 142 on behalf of the BOTP payment service 104, as described above.

Of course, at this juncture, the payer may himself use the received code for withdrawing cash from an ATM, rather than using the code for making a payment as will now be described.

### Payment Completion

According to examples there are a number of potential ways in which the recipient may complete or conclude a payment. At the point of receiving the payment code, the recipient has not actually received the funds. Instead, the recipient has received the means (payment code) by which funds can be recovered, subject to completion of additional process steps, optionally, within a certain specified period of time.

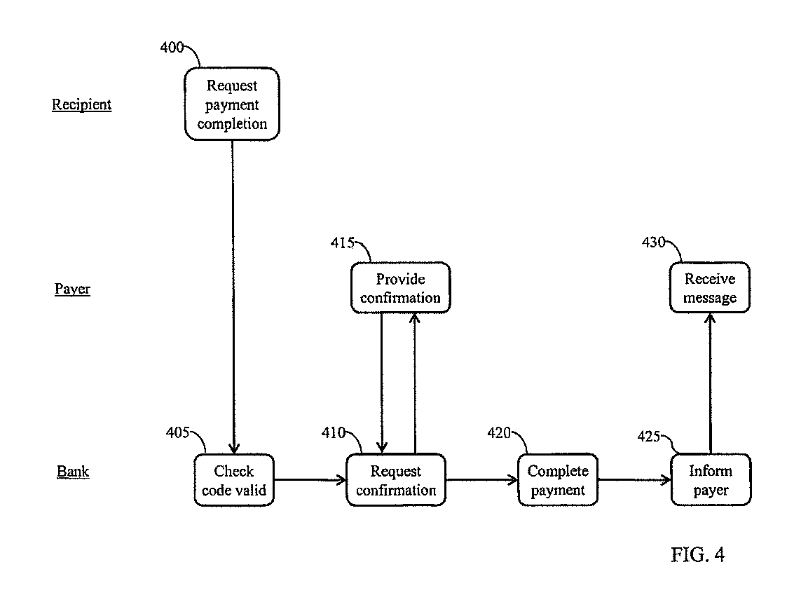

An exemplary process for completing payment will now be described with reference to the flow diagram in FIG. 4.

In a first step [400], the recipient requests payment completion (for example, by bank account transfer or by ATM cash withdrawal) by causing the payment code to be communicated to the customer account service 102. The customer account service 102 checks that the payment code is valid [405] and, optionally, communicates a confirmation request message, for example, securely to the payer PCD 142 [410]. In response to the optional confirmation request message, the payer has the option to approve or deny the payment [415]; and even contact the recipient to ensure that it is they who are attempting to complete the payment transaction. In response to approval by the payer, for example by using the payment delivery application to communicate an approval message to the customer account service 102, the customer account service 102 completes the payment [420], for example by causing a respective ATM to deliver an associated amount of cash or transfer of funds from the client account (although the funds have already been ring fenced and so the customer account 118 balance would not change) to another account specified by the recipient, as will be described. If a confirmation request procedure is not required, steps 410 and 415 are not performed. The process could end here. However, optionally again, the customer account service 102 sends a message to the payer PCD 142 [425] indicating that the payment has been completed, which message is received by the payer PCD [430].

As has already been indicated, according to certain examples, completion of the process can be performed by the recipient using the payment code to withdraw cash from an ATM. According to certain other examples, completion of the process can be performed by the recipient using the payment code to transfer funds from the payer's account to an account of the recipient. An example of each kind of example for completing the process will now be described.

### ATM Examples

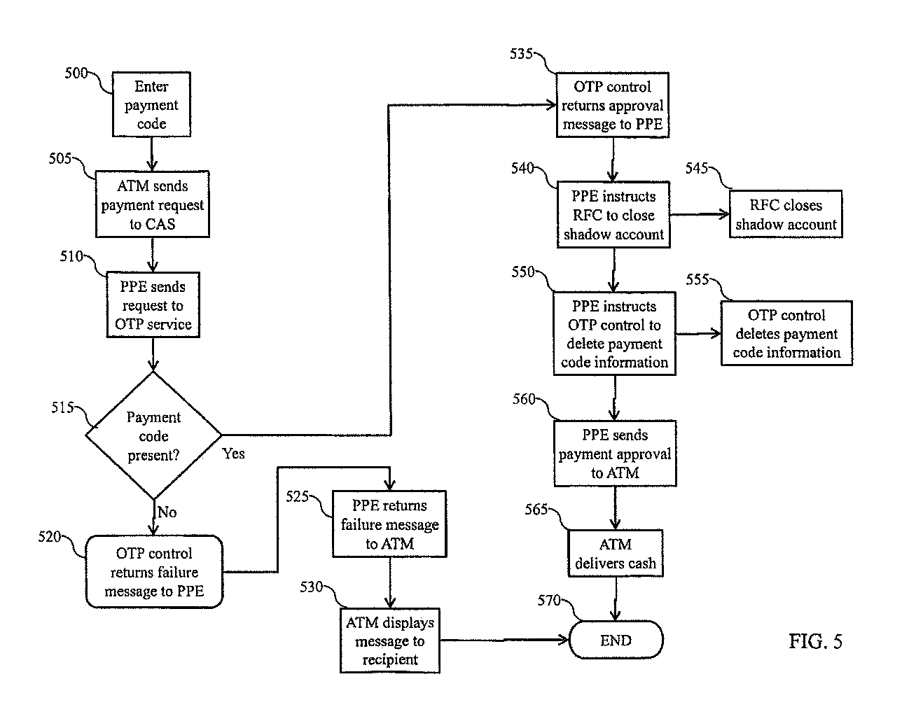

According to one example, the recipient can withdraw cash in the amount of the received payment at an ATM, according to the process illustrated in FIG. 5. In a first step [500], the recipient approaches an ATM 134 in order to withdraw funds, selects a cardless payment option and enters the payment code when prompted to do so. In some examples, for added security, the recipient may also be required to enter the payment amount, which he would have learned directly from the payer at the point of making the payment.

In alternative examples it is expected that an ATM may be arranged to interact directly with a PCD, for example via NFC, imaging of a PCD screen displaying the code, or in any other appropriate way. For the present example, however, the recipient manually enters the payment code into the ATM 134, by reference to the payment code, which can be displayed by the recipient PCD 144. It is known that ATMs can be arranged to permit cash withdrawals without requiring an ATM card, and that facility is employed according to an exemplary process as follows.

The ATM 134 sends a respective cardless payment request (including the code and optionally the payment amount), via the ATM network 135 and bank gateway 132, to the customer account service 102 [505]. The payment processing engine 108 sends the cardless payment request to the BOTP payment service 104 [510], in which the BOTP control 129 compares the payment code and optionally the amount information to information stored in the BOTP store 124 [515] to determine if the payment code is present and hence valid. If the information in the cordless payment request cannot be matched to information in the BOTP store 124, the BOTP control 129 returns a failure message to the payment processing engine 108 [520]; and the payment processing engine 108 returns a respective failure message to the ATM 134 [525], which displays an appropriate message to the recipient [530]. If, however, the information in the cardless payment request is matched to information in the BOTP store 124 (the optional step of obtaining confirmation from the recipient may be performed at this point but will not be described again, for simplicity of description only), the BOTP control 129 sends an approval message to the payment processing engine 108 [535]. In response, the payment processing engine 108 instructs the ring fence control 110 to close the shadow customer account 120 [540] (which the ring fence control 110 does [545]), instructs the BOTP control 129 to mark as paid the associated payment code information in the BOTP store 124 [550] (which the BOTP control 129 does [555]) and then sends a payment approval message to the ATM 134 [560]. On receiving the payment approval message, the ATM 134 delivers the respective amount of cash to the recipient [565]. The ATM 134 returns a payment completed notification to the payment processing engine 108. At that point, the process has been completed [570], although, as described above (not shown in FIG. 5), a message may be communicated to the payer PCD 142 indicating to the payer that the payment has been completed.

It will be appreciated that, according to the foregoing example, the recipient has been able to withdraw the specified amount of cash from an ATM without having to provide any identification information and without even having to have a bank account of their own. In principle, all that is required is entry of the payment code into an appropriately arranged ATM. Of course, in the example provided, the recipient can also be required to provide the amount of the payment, but this is merely an optional step to add an element of security (for example, to increase the difficulty a fraudster would have to successfully withdraw cash from an ATM by entering random numeric strings).

The present example as described will operate, to permit cardless cash withdrawals from an ATM, if the recipient interacts with an ATM belonging to the same bank as the payer: because only the payer's bank system 100 has knowledge of the payment code. In alternative examples, the payment code includes a prefix comprising one or more numbers (for example a bank sort code, which in the UK has six numeric characters), to identify the bank that generated the payment code. In this way, and assuming an appropriate inter-bank process is in place, a third party ATM would be able to deliver cash, by obtaining approval from the payer's bank system 100 (and establishing a respective cross-charge between banks).

### Funds Transfer Examples

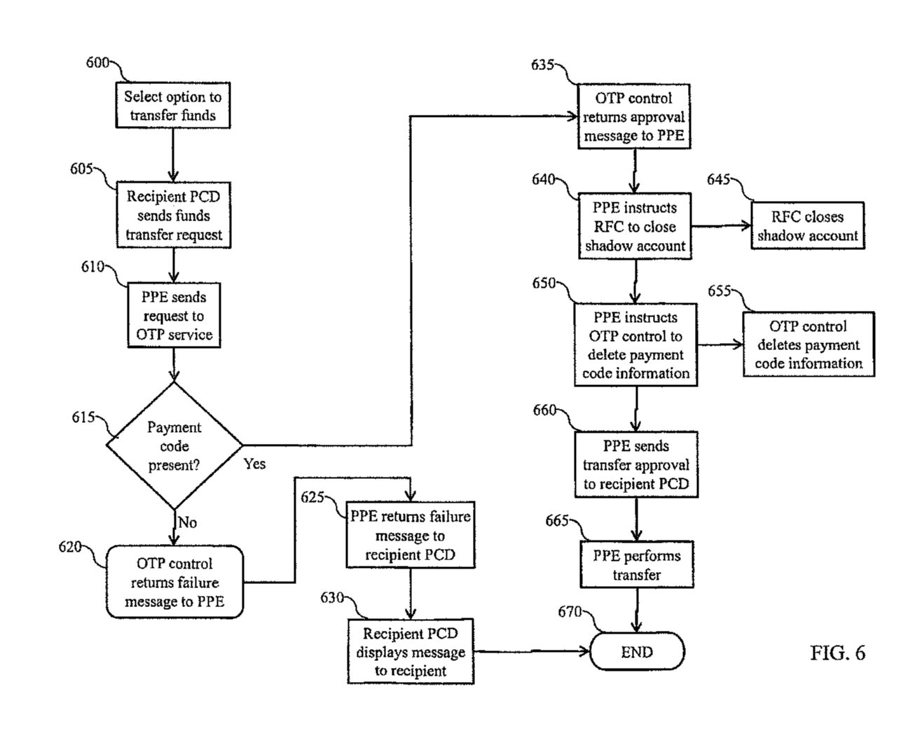

According to one example, for example in a situation in which a recipient has not been able to reach an ATM in time, the recipient can instead opt to transfer funds to a specified bank account, according to the process illustrated in FIG. 6. In a first step [600], the recipient selects on the recipient PCD 144 an option to transfer funds, according to the payment code and amount information, into a bank account of the recipient. The details of the bank account of the recipient may be programmed into the recipient PCD 144, provided by the recipient or, once logged on to their bank, the bank may be able to match the recipient PCD 144 with an appropriate recipient account. The recipient PCD 144 in response sends a funds transfer request (including the payment code, optionally confirmation of the payment amount and, if required, a bank account identifier), via the cellular network 138 and bank gateway 132, to the customer account service 102 [605]. The payment processing engine 108 sends the funds transfer request to the BOTP payment service 104 [610], in which the BOTP control 129 compares the payment code and amount information to information stored in the BOTP store 124 [615] to determine if the payment code is present and hence valid. If the information in the funds transfer request cannot be matched to information in the BOTP store 124, the BOTP control 129 returns a failure message to the payment processing engine 108 [620]; and the payment processing engine 108 returns a respective failure message to the recipient PCD 144 [625], which displays an appropriate message to the recipient [630]. If, however, the information in the funds transfer request is matched to information in the BOTP store 124 (the optional step of obtaining confirmation from the recipient may be performed at this point but will not be described again, for simplicity of description only), the BOTP control 129 sends an approval message to the payment processing engine 108 [635]. In response, the payment processing engine 108 instructs the ring fence control 110 to close the shadow customer account 120 [640] (which the ring fence control 110 does [645]), instructs the BOTP control 129 to delete the associated payment code information from the BOTP store 124 [650] (which the BOTP control 129 does [655]) and then sends a transfer approval message to the recipient PCD 144 [660]. In addition, the payment processing engine 108 instructs a transfer of funds to the identified bank account [665]. At that point, the process has been completed [670], although, as described above (not shown in FIG. 6), a message may be communicated to the payer PCD 142 indicating to the payer that the payment has been completed.

In examples in which the customer account 118 of the payer and the identified account of the recipient are maintained in the same bank system, such a transfer of funds from the payer to the recipient is typically relatively straightforward. In other examples in which the customer account 118 of the payer and the identified account of the recipient are not with the same bank and are not maintained in the same bank system, it may be necessary to conform to existing interbank transaction standards to perform the transfer. For example, existing interbank transaction standards may not permit payments to be ‘pulled’ (that is, requested) by a recipient's bank from the payer's bank: instead, a payment may have to be ‘pushed’ (that is, sent) by the payer's bank to the recipient's bank. The funds transfer process described above conducts a payment in this manner, with the payer's bank pushing funds, via the bank gateway 132 and interbank network 137, to the third party bank system 136. In order to facilitate the funds transfer instruction, the payer's bank system 100 is arranged to interact with the recipient, who does not have a customer account in the bank system 100. As will be appreciated, it is not usual for a bank (and its systems) to interact with people who are not customers, having pre-established banking relationships, customer accounts and personal login information. However, in the same manner in which a non-customer is able withdraw cash from an ATM without having an account (and ATM card) with the respective bank, examples herein facilitate communications between a bank system 100 and parties who are not customers; the only requirement being that a party is a recipient who has a valid payment code.

Of course, in order for a non-customer recipient to interact with the bank system 100, the recipient needs to know how to control their recipient PCD 144 to contact the appropriate bank system 100. There are a number of ways of achieving this. For example, the funds transfer process may simply be initiated, if the recipient directs its recipient PCD 144 to a home web page of the respective bank and selects a ‘Non-customer funds transfer service’ (that is provided according to the present example), which provides the recipient PCD 144 with a means for presenting a payer code, an amount and appropriate bank account identifier.

According to examples of the disclosure, additional information is provided by the payer PCD 142 to the recipient PCD 144 during the PTP payment process. More particularly, at step [250] of the PTP payment process, the additional information sent to the recipient PCD 144 comprises a network address (or network service address), for example an IP address or URL, that can subsequently be used by the recipient PCD 144 to contact the bank system 100, in the event that a funds transfer procedure is required. In practice, the address could take the recipient PCD 144 to the bank gateway 132, which could then direct the message to the customer account service 102.

According to alternative examples, the bank system 100 and third party bank system 136 are arranged to facilitate ‘pulled’ payments. In such cases, a recipient should be able to communicate with his own bank to request a funds transfer based on the payment code, the amount and, in addition, an indication of an identity of the payer's bank. Again, an identity of the payer's bank may be provided, for example, at step [250] of the payment process. Then, based on the identity, the third party bank system 136 can contact the bank system 100 to arrange the funds transfer.

It will be appreciated that, according to the foregoing example, the recipient has been able to arrange a transfer of funds irrespective of whether or not the recipient banks at the same bank as the payer.

Another alternative way of managing interbank funds transfers, according to examples of the present disclosure, is for a third party service provider to manage the payments—in terms of issuing and redeeming payment codes—on behalf of the banks. The third party payments provider could either be set-up by banks who want to offer the service, or it could be a service to which banks can subscribe in order to offer the service to their respective customers. Appropriate APIs would need to be established between the banks and the service provider, in order for the service provider to be able to manage payment set-up and completion.

### Ring Fence Control

As has already been indicated, if a payment is not completed, for example within a set time period, the ring-fencing can be reversed. According to examples, a payment associated with a payment code has to be completed ‘by the recipient’ within a period of time, for example a standard fixed period of, say, two hours from the time when the payment was first set up by the payer. In other words, time period includes the time before the payment is made by the payer to the recipient and the time before the recipient concludes the payment. Alternatively, the payer PCD 142 may be adapted to communicate to the bank system 100 when the payment has been made to a recipient, and the time limit may then be set to start from that point; so that the payer is not under time pressure to make a payment. In any event, the payer PCD 142 may be arranged to inform the payer and even the recipient PCD 144 of how long the payment code is valid for.

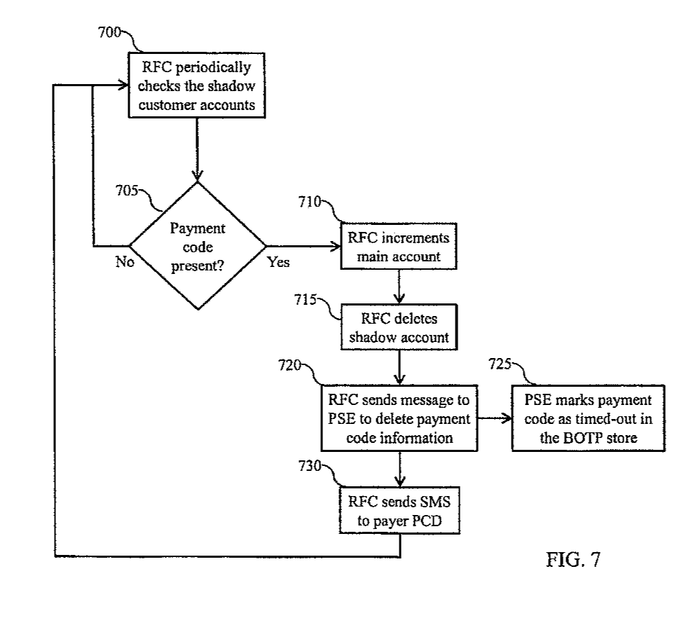

Ring-fencing reversal can be achieved according to the flow diagram in FIG. 7. According to a first step [700], periodically (for example, every ten minutes), the ring fence control 110 scans the shadow customer accounts 116 to determine if any shadow customer account 120 has passed its valid period, for example by reference to a time stamp provided to each account when it was set up by the ring fence control 110. For any shadow customer account 120 that has expired [705], by having passed the valid period, the ring-fenced amount in the shadow customer account 120 is incremented into the associated main customer account 118 [710] and the shadow customer account 120 is deleted [715]. In effect, the ring-fencing has been reversed and the funds are returned to the customer account 118, and the balance in the customer account 118 is adjusted to reflect the increment. In addition, the ring fence control 110 may send a message to the payment setup engine 128 [720], which in turn marks the payment code information as timed-out in the BOTP store 124 [725], so that any subsequent attempt to use the payment code would fail. This step may not be deemed necessary, however, according to an example in which the conclusion of any payment includes a check for an associated shadow customer account 120 (which has already been deleted). Finally, and optionally, the fact that the payment code is no longer valid and/or that the recipient has not used the payment code in time, is communicated to the payer [730], for example, via SMS or by other secure means. The process then iterates to the first step [700]. Of course, a similar ring-fence removal process may be applied when ring-fencing is processed within a main account rather than by using shadow accounts. Additionally, or alternatively, ring-fence removal may be performed using period batch processing (e.g. every hour or other appropriate period), via notification services, or in any other appropriate way. Of course, whenever a BOTP has been used or times-out and is deactivated in an appropriate way, the code may be re-used in another transaction without causing any conflicts. Accordingly, there does not need to be an unreasonably large number of available codes, and codes can be kept commensurately short.

### DTD Payment Protocol

Payments according to the present example may be made using near field communications (NFC) signalling. According to the present example, both payer and recipient PCDs include integrated NFC transceivers (or equivalent), which can be initialised for sending and receiving data, depending on whether a respective device is required to send or receive data.

Nowadays, PCDs having NFC transceivers are commonplace. Such devices can therefore perform contactless communication, for example at 13.56 MHz, with various types of electronic devices, such as NFC-enabled PCDs and other NFC-enabled equipment. Further details of well-known NFC protocols do not need to be provided herein.

Alternative wireless communications systems, suitable for use according to examples of the present disclosure, may employ IR, Bluetooth or WiFi signalling. However, a benefit of NFC over at least the latter two options is that PCDs have to be very close together in order to interact, and false payments (for example with unintended, nearby devices) are less likely than with Bluetooth or WiFi, which are capable of communicating over tens or hundreds of meters. As has already been alluded to, recipient PCD camera could be employed to image payment codes that are displayed on a payer PCD screen: such codes could be alpha-numeric or encoded, for example, as 2D or 3D barcodes or the like.

### Alternative Payment Codes

Thus far, payment codes have typically comprised alpha and/or numeric strings; with a recipient having to enter the string into an ATM or control their smartphone to use the string in an account funds transfer process. In alternative examples, other kinds of payment code are envisaged; for example 2-D or 3-D barcodes (or any other graphically encoded payment code). Such codes can be displayed on the screen of the recipient's smartphone and ‘imaged’ by an ATM (or any other suitable equipment or apparatus within or outside of a bank), which has been enabled with, for example, a camera or scanner. In this way, the recipient would not need to enter numbers manually into an ATM (or any other suitable equipment or apparatus within or outside of a bank). Of course, such an interface to an ATM need not use imaging at all; for example, the smartphone may be equipped with NFC, Bluetooth or another proximity communications arrangement, for communicating the payment code to a suitably equipped ATM (or any other suitable equipment or apparatus within or outside of a bank). Indeed, the bank may also hand over cash manually, when a recipient shows a recipient PCD 144 displaying a valid code (which would need to be checked on the bank system 100 by the respective bank employee).

### Bank System Architecture

It will be appreciated that the arrangement of the bank system 100, the customer account service 102, the various APIs, the bank gateway 132 and all other components and functions of the overall architecture are described herein by way of example only and, as will be appreciated by the skilled person, by the very nature of computer implemented systems in general, many other system arrangements and configurations may be used instead to perform generally the same functions. The bank system 100 may, for example, comprise a mainframe computer operating the z/OS operating system and performing all of the various transactions using CICS, with appropriate databases being employed to store and manage customer accounts and the like. Suitable web service and telephone integration elements can also be adapted and provided as required.

### Exemplary PCD

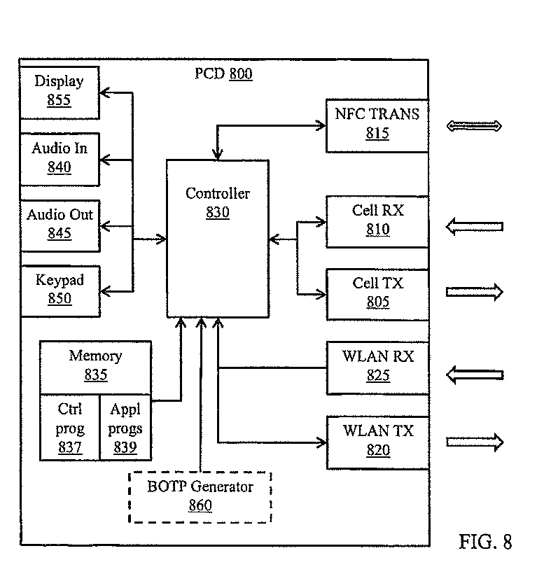

A PCD that can operate as a payer PCD 142 and/or a recipient PCD 144 is illustrated functionally in the diagram in FIG. 8. The PCD 800 in this example is a smartphone that can perform standard cellular (e.g. GSM) communications in addition to NFC and WLAN (Wi-Fi) communications. The PCD 800, includes a cellular transmitter 805 and a cellular receiver 810. In addition, or alternatively, the PCD 800 can communicate via NFC using an NFC transceiver 815 and via WLAN via a WLAN transmitter 820 and a WLAN receiver 825 arrangement. All such transmitter/receiver/transceiver elements are well known. The PCD 800 further includes a controller 830, which typically comprises an embedded control processor, and which controls the overall operation of the PCD 800, including the operation of the various wireless/radio interfaces. The controller 830 operates in accord with a control program 837 and various application programs 839 that are stored in a memory 835, which may include non-volatile (e.g. Flash) and volatile memory elements. The PCD 800 also includes standard user interface elements, such as Audio In 840, Audio Out 345, a keypad 850 and a display 855: if the display is touch sensitive, the keypad may not be present.

As also shown in FIG. 8, the PCD 800, optionally, includes a BOTP generator 860, for generating BOTPs. Such a generator, if present, is used according to certain examples to generate a BOTP that is used in a payment transactions, rather than relying on a BOTP generator 122. Accordingly, a BOTP generator 122 may not be required in the bank system 100 (or may only be required when a PCD BOTP generator 860 is not available). In operation, a PCD-resident BOTP generator 860 would generate a BOTP as required when initiating a payment transaction, and would securely communicate the BOTP to the bank system 100 when setting up a payment transaction. BOTPs generated in this way, by a PCD, may be adapted so that they are unique to a particular PCD, so that different PCDs cannot accidentally generate the same BOTPs. Indeed, in principle at least, there is no reason why a recipient PCD 144 could not generate the code and pass it to the bank system 100 via the payer PCD 142.

The above examples are to be understood as illustrative examples of the disclosure. Further examples of the disclosure are envisaged, and would, on the basis of the foregoing disclosure, be evident to the skilled person. It is to be understood that any feature described in relation to any one example may be used alone, or, if the context permits, in combination with other features described, and may also be used in combination with one or more features of any other of the examples, or any combination of any other of the examples. Furthermore, equivalents and modifications not described above may also be employed without departing from the scope of the disclosure, which is defined in the accompanying claims.

1. A method of performing a person-to-person payment, from a wireless personal communications device of an originator to a wireless communications device of a recipient, by transferring a respective blind payment identifier, which is associated with a payment having a monetary value, from a wireless personal communications device of the originator to a wireless personal communications device of the recipient by using a direct device-to-device communications protocol.

2. A method according to claim 1, including initiating the payment at a remote payment system, which performs operations in respect of a financial account of the originator.

3. A method according to claim 2, wherein initiating the payment comprises authenticating the originator at the remote payment system and obtaining payment identifier information from the remote payment system.

4. A method according to claim 2, wherein initiating the payment further comprises ring-fencing the monetary value at the financial account and associating the ring-fencing with the payment identifier.

5. A method according to claim 2, wherein the initiating step comprises identifying a monetary value and not identifying the recipient.

6. A method according to claim 2, wherein the step of initiating is performed before performing the payment.

7. A method according to claim 1, comprising the step of the recipient obtaining post-payment authorisation to receive funds amounting to the monetary value.

8. A method according to claim 7, wherein the post-payment authorisation is provided by the originator.

9. A method according to claim 8, wherein the post-payment authorisation is provided in response to an authorisation request, which is initiated by the recipient.

10. A method according to claim 9, wherein the recipient initiates the request at the remote payment system, and the payment system communicates with the originator in order to obtain the authorisation.

11. A method according to claim 10, wherein the recipient initiates the request via an ATM, which communicates with the payment system.

12. A method according to claim 8, wherein the post payment authorisation is provided in response to identifying the recipient and/or the respective monetary amount.

13. A personal communications device, comprising:
means arranged to communicate wirelessly with a remote payment system to set up a payment therewith including by obtaining and storing a blind payment identifier; and
means arranged to communicate directly with a proximal, second personal communications device and impart the blind payment identifier thereto.

14. A personal communications device according to claim 13, comprising an application program for performing the means arranged to communicate wirelessly and means arranged to communicate directly.

15. A method of performing a transaction comprising:
a requester controlling a wireless personal communications device to communicate wirelessly with a remote payment system to obtain a payment identifier having a specified monetary value;
the remote payment system generating the payment identifier, associating it with the monetary value, including by ring-fencing the monetary value in an account of the respective requester, and returning the payment identifier to the wireless personal communications device; and
the requester causing the payment identifier to be received by a cash dispensing machine, whereby the cash dispensing machine validates the payment identifier with the remote payment system and delivers a respective amount of cash to the requester.
